(19) United States
(12) Patent Application Publication
(10) Pub. No.: US 2023/0125436 A1
(43) Pub. Date: Apr. 27, 2023

(54) METHOD FOR GENERATING NEURAL NETWORK ARCHITECTURE AND COMPUTING APPARATUS EXECUTING THE SAME

(71) Applicants: SAMSUNG SDS CO., LTD., Seoul (KR); CHUNG ANG University industry Academic Cooperation Foundation, Seoul (KR)

(72) Inventors: Ju Youn Son, Seoul (KR); Jeong Seon Yi, Seoul (KR); Eun Woo Kim, Seoul (KR)

(21) Appl. No.: 17/972,840

(22) Filed: Oct. 25, 2022

(30) Foreign Application Priority Data
Oct. 27, 2021 (KR) 10-2021-0144342

(51) Int. Cl. G06N 3/04; G06N 3/08

(52) U.S. Cl. CPC G06N 3/04; G06N 3/082

(57) ABSTRACT

A method for generating artificial neural network architecture includes selecting any one of a plurality of artificial neural network architectures as a backbone architecture, calculating weights of a plurality of candidate operation blocks applicable to each stage for each of one or more stages constituting the backbone architecture, replacing or removing at least one of the plurality of candidate operation blocks based on the calculated weight, and repeatedly performing the calculating of the weight and the replacing or removing the at least one candidate operation block by a preset number of times to configure a final candidate operation block set for each stage and select any one of the final candidate operation block as an operation block of a corresponding stage.

### CROSS-REFERENCE TO RELATED APPLICATION AND CLAIM OF PRIORITY

This application claims the benefit under 35 USC § 119 of Korean Patent Application No. 10-2021-0144342, filed on Oct. 27, 2021 in the Korean Intellectual Property Office, the disclosure of which is incorporated herein by reference in its entirety.

### BACKGROUND

### 1. Field

The present disclosure relates to technology for automatically generating artificial neural network architecture.

### 2. Description of Related Art

With the recent surge in demand for AI application services, AutoML technology for automating the creation of artificial neural network models has come to prominence. In particular, in the field of deep learning, research related to neural architecture search (NAS) for automatically constructing a neural network suitable for target data has been actively conducted.

In the case of a traditional neural network architecture search, neural network architecture was searched by selecting a candidate architecture and repeating the task of evaluating performance of the selected architecture. In the case of this method, however, there is a problem in that computing resources were excessively consumed because a large number of architectures should be evaluated. For example, when a reinforcement learning-based search strategy was used, 2000 GPU Days or more could be consumed in some cases. Accordingly, in recent studies, a gradient-based search method consuming relatively little resources, a method of reducing resource usage in a search process, or the like, has been proposed. However, these studies also have limitations in effectively reducing the amount of resources consumed for search, and it is difficult to achieve expected performance compared to resources being consumed.

### SUMMARY

Exemplary embodiments provide technical means for effectively searching for artificial neural network architecture and generating an optimal artificial neural network architecture therefrom.

According to an aspect of the present disclosure, a method performed in a computing apparatus including one or more processors and a memory storing one or more programs executed by the one or more processors, including: selecting any one of a plurality of artificial neural network architectures as a backbone architecture; calculating weights of a plurality of candidate operation blocks applicable to each stage for each of one or more stages constituting the backbone architecture; replacing or removing at least one of the plurality of candidate operation blocks based on the calculated weight; and repeatedly performing the calculating of the weight and the replacing or removing the at least one candidate operation block by a preset number of times to configure a final candidate operation block set for each stage and select any one of the final candidate operation block as an operation block of a corresponding stage.

The calculating a weight may include calculating weights of the plurality of candidate operation blocks using a gradient-based search algorithm.

A loss function of the gradient-based search algorithm may include an operation term for causing the number of parameters of the candidate operation blocks selected for each stage of the backbone architecture to converge to a preset target number of parameters.

The replacing or removing of the at least one candidate operation block may further include replacing at least one candidate operation block having a low weight, among the candidate operation blocks, with another candidate operation block.

The replacing or removing of the at least one candidate operation block may further include replacing a candidate operation block having the lowest weight, among the candidate operation blocks, with a candidate operation block having the highest weight.

The replacing or removing of the at least one candidate operation block may further include removing a candidate operation block having the lowest weight, among the candidate operation blocks.

According to an aspect of the present disclosure, a computing apparatus includes: one or more processors; a memory; and one or more programs, wherein the one or more programs are stored in the memory and configured to be executed by the one or more processors, wherein the one or more programs includes an instruction for performing selection of any one of a plurality of artificial neural network architectures as a backbone architecture; calculating weights of a plurality of candidate operation blocks applicable to each stage for each of one or more stages constituting the backbone architecture; replacing or removing at least one of the plurality of candidate operation blocks based on the calculated weight; and repeatedly performing the calculating of the weight and the replacing or removing the at least one candidate operation block by a preset number of times to configure a final candidate operation block set for each stage and select any one of the final candidate operation block as an operation block of a corresponding stage.

The calculating a weight may include calculating weights of the plurality of candidate operation blocks using a gradient-based search algorithm.

A loss function of the gradient-based search algorithm may include an operation term for causing the number of parameters of the candidate operation blocks selected for each stage of the backbone architecture to converge to a preset target number of parameters.

The replacing or removing of the at least one candidate operation block may further include replacing at least one candidate operation block having a low weight, among the candidate operation blocks, with another candidate operation block.

The replacing or removing of the at least one candidate operation block may further include replacing a candidate operation block having the lowest weight, among the candidate operation blocks, with a candidate operation block having the highest weight.

The replacing or removing of the at least one candidate operation block may further include removing a candidate operation block having the lowest weight, among the candidate operation blocks.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a flowchart illustrating a method for generating artificial neural network architecture according to an exemplary embodiment;

FIGS. 2A to 2D are diagrams illustrating a DARTS algorithm used in the disclosed exemplary embodiments;

FIG. 3 is a diagram illustrating a process of updating a candidate operation block according to an exemplary embodiment;

FIG. 4 is a diagram illustrating an implementation example of a method for generating artificial neural network architecture according to an exemplary embodiment; and

FIG. 5 is a block diagram illustrating a computing environment including a computing apparatus suitable for use in exemplary embodiments.

### DETAILED DESCRIPTION

Hereinafter, exemplary embodiments of the present disclosure are described with reference to the accompanying drawings. The following description is provided to aid in the comprehensive understanding of methods, devices, and/or systems disclosed in the particularities. However, the following description is merely exemplary and not provided to limit the present disclosure,

In the following description of the present disclosure, a detailed description of known functions and configurations incorporated herein will be omitted when it would make the subject matter of the present disclosure unclear. The terms used in the present specification are defined in consideration of functions used in the present disclosure, and may be changed according to the intent or conventionally used methods of clients, operators, and users. Accordingly, definitions of the terms should be understood on the basis of the entire description of the present specification. Terms used in the following description are merely provided to describe exemplary embodiments of the present disclosure and are not intended to be limiting of the inventive concept. As used herein, the singular forms “a,” “an” and “the” are intended to include the plural forms as well, unless the context clearly indicates otherwise. It will be further understood that the terms “comprises” or “has” when used in this specification, specify the presence of stated features, integers, steps, operations, elements, or a portion or combination thereof, but do not preclude the presence or addition of one or more other features, integers, steps, operations, elements, or a portion or combination thereof.

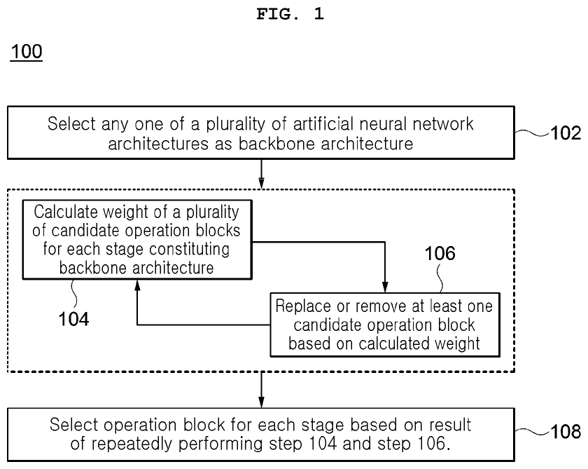

FIG. 1 is a flowchart illustrating a method 100 for generating artificial neural network architecture according to an exemplary embodiment. The illustrated method may be performed in a computing apparatus including one or more processors and a memory storing one or more programs to be executed by the one or more processors. In the illustrated flowchart, the method or process are described to be divided into a plurality of steps, but at least some of the steps are performed in a different order, may be combined with another step to be performed together, may be omitted, or may be divided into sub-steps to be performed, or one or more steps not illustrated may be added thereto to be performed.

In step 102, the computing apparatus selects any one of a plurality of artificial neural network architectures, as a backbone architecture. In an exemplary embodiment, the computing apparatus may select one network (Super Net) that has good performance, among known artificial neural network architectures, and is suitable for use as the backbone architecture. The computing apparatus may block each layer constituting the selected backbone architecture. For example, artificial neural network architecture used in the field of computer vision may be configured to include a plurality of convolution layers, and the computing apparatus may set each convolutional layer as a block. In the following description, “stage” or “layer” may be used interchangeably as a term referring to blocks of the backbone architecture set in this manner.

In step 104, the computing apparatus selects a plurality of candidate operation blocks applicable to each stage for each of one or more stages constituting the backbone architecture, and calculates weights thereof. This step and step 106 to be described below are steps for selecting an operation to be applied to each stage of the backbone architecture. That is, if the entire artificial neural network architecture is determined through step 102, the following steps are steps for designing a detailed operation to configure the determined architecture (backbone architecture).

In an exemplary embodiment, the computing apparatus may determine candidate operation blocks for each stage by using a plurality of operation blocks included in a preset operation block pool. Thereafter, the computing apparatus may calculate weights of the plurality of candidate operation blocks using a gradient-based search algorithm. For example, the computing apparatus may calculate weights of the plurality of candidate operation blocks using a differential architecture search (DARTS) algorithm. DARTS is an algorithm for calculating a weight a of the candidate operation blocks for each stage through a process of optimizing a weight parameter α related to a selection probability of a plurality of candidate operations and the weight w of each operation, and calculating an optimal candidate operation block.

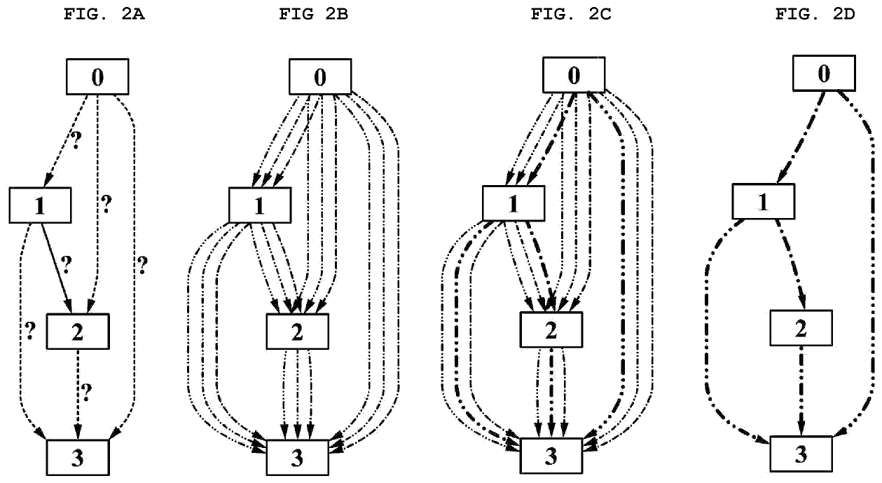

FIGS. 2A to 2D are diagrams illustrating the DARTS algorithm used in the disclosed exemplary embodiments. Like other network architecture search (NAS) algorithms, DARTS also uses a directed acyclic graph (DAG). In FIGS. 2A to 2D, nodes from 0 to 3 are cells, and the edge connecting the nodes corresponds to an operation.

FIG. 2A illustrates a state in which operations connecting cells are not yet determined, and FIG. 2B illustrates a state in which three candidate operations are selected for each node. In the drawings, different calculations are expressed by different types of lines. In the DARTS algorithm, the weight w of each operation is first optimized, and the weight parameter α of each operation is adjusted so that loss Lᵥₐₗ of the overall architecture obtained by weighting each operation using the weight parameter α is minimized. FIG. 2C illustrates a state in which the weight parameter α is adjusted through this process. In the drawing, the thickness of each line indicates a weight parameter α assigned to the corresponding operation. Finally, FIG. 2D illustrates a state in which one operation having the highest weight parameter α is selected at each edge. In the disclosed exemplary embodiment, the process (d) may be performed in step 108.

In an exemplary embodiment, the computing apparatus may randomly set an initial value of the weight parameter α of the candidate operation block for each stage. In another exemplary embodiment, the computing apparatus may set the weight parameter α so that a specific candidate operation block is highlighted. For example, if the number of candidate operation blocks in a specific stage is four, the computing apparatus may set the weight parameter α of each candidate operation block so that the second candidate operation block is highlighted as follows.

{α1, α2, α3, α4}={0.1, 0.7, 0.1, 0.1}

In this case, αₖ denotes a weight parameter of the k-th candidate operation block.

Next, in step 106, the computing apparatus replaces or removes at least one candidate operation block among the plurality of candidate operation blocks based on the weight calculated in step 104. This step is a step of updating the candidate operation block using mutation, which is one of the techniques used in the evolutionary algorithm.

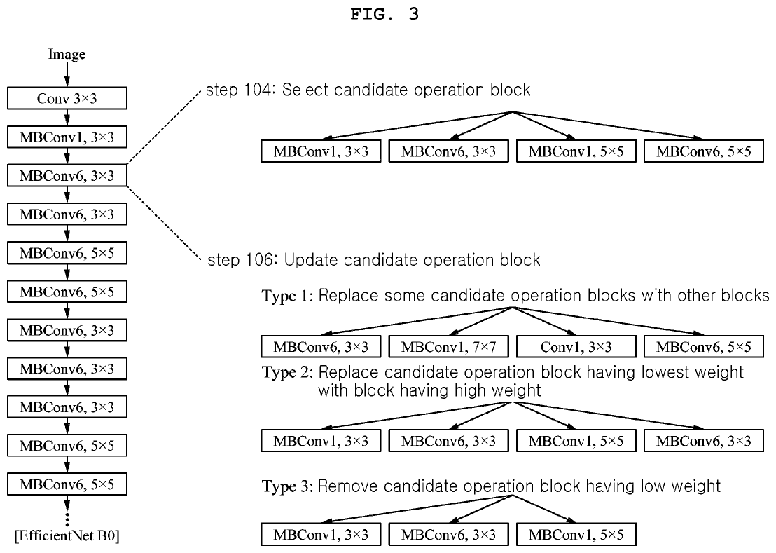

FIG. 3 is a diagram illustrating a process of updating a candidate operation block according to an exemplary embodiment. For example, it is assumed that four candidate operation blocks ((MBConv1, 3×3), (MBConv6, 3×3), (MBConv1, 5×5), (MBConv6, 5×5) are selected as candidate operation blocks to enter a specific stage of a backbone architecture as illustrated on the left of FIG. 3. As illustrated, the mutation may be roughly divided into the following three types.

A first type (Type 1) is to replace at least one candidate operation block having a low weight, among candidate operation blocks, with another candidate operation block. For example, it is assumed that (MBConv6, 5×5) has the largest weight parameter α value, among the above four candidate operation blocks. Then, the computing apparatus may replace the other blocks than the corresponding block with other candidate operation blocks included in an operation block pool.

A second type (Type 2) is to replace a candidate operation block having the lowest weight, among the candidate operation blocks, with a candidate operation block having the highest weight. For example, it is assumed that (MBConv6, 3×3) has the largest weight parameter α value and (MBConv6, 5×5) has the smallest weight parameter α value, among the four candidate operation blocks. The computing apparatus may then replace (MBConv6, 5×5) with (MBConv6, 3×3).

A third type (Type 3) is to remove a candidate operation block having the lowest weight, among the candidate operation blocks. For example, when the weight parameter α value of (MBConv6, 5×5) is the smallest, among the above four candidate operation blocks, the computing apparatus may delete the corresponding candidate operation block and leave only three candidate operation blocks.

Referring back to FIG. 1, in step 108, the computing apparatus repeats steps 104 and 106 by a predetermined number of times to construct a final candidate operation block set for each stage. The computing apparatus may repeat a process of calculating a weight parameter that is a selection probability of each candidate operation block by using the gradient-based algorithm in step 104 and excluding the candidate operation block having a small weight parameter from the candidate group or replacing the candidate operation block having a small parameter with another block based on the evolutionary algorithm in step 106, thereby leaving only a candidate group having high operation performance. That is, in the process of continuously updating a search space for selecting an operation block through the evolutionary algorithm, operation blocks with low performance are continuously removed, thereby obtaining an effect of highlighting more optimized operation blocks.

Thereafter, the computing apparatus selects any one candidate operation block, among the final candidate operation blocks, as an operation block of the corresponding stage.

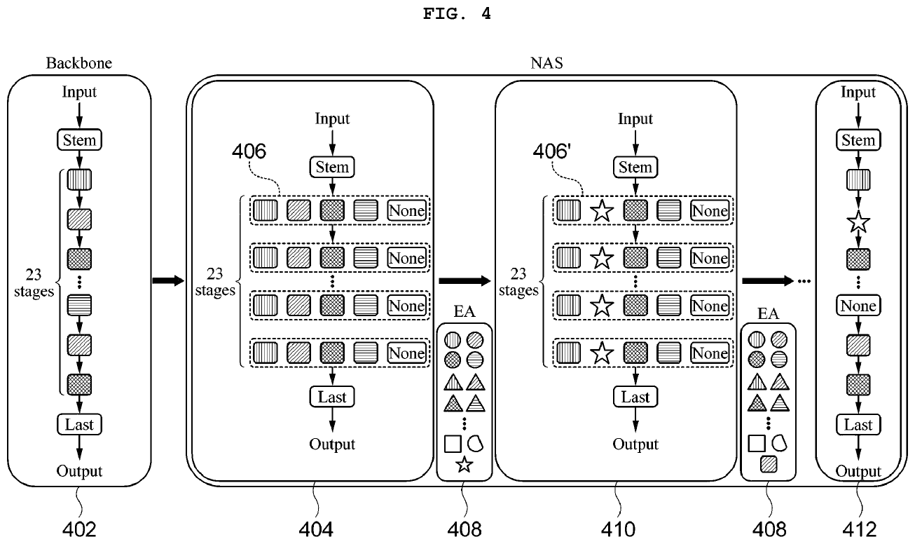

FIG. 4 is a diagram illustrating an implementation example of the method 100 for generating artificial neural network architecture according to an exemplary embodiment. Reference numeral 402 denotes a backbone architecture including 23 stages. Reference numeral 404 denotes a backbone architecture in a state in which a set 406 of candidate operation blocks for each stage is configured in step 104 as described above and the weight of each candidate operation block in the set is calculated. It is to be noted that, in the drawing, candidate operation blocks include “None”, that is, a block indicating that no operation is performed in the corresponding stage.

Thereafter, the computing apparatus replaces some candidate operation blocks in the set 406 of the candidate operation blocks for each stage with other blocks in the candidate operation pool 406 based on the evolutionary algorithm (EA). Reference numeral 410 denotes a backbone architecture including a candidate operation block 406′ in which some blocks have been replaced through this process.

Finally, reference numeral 412 denotes a completed artificial neural network architecture in which an optimal operation block for each stage is selected.

Meanwhile, a loss function of the gradient-based search algorithm used in step 104 described above may include an operation term for allowing the number of parameters of the candidate operation blocks selected for each stage of the backbone architecture to converge to a preset number of target parameters. This will be described in more detail as follows.

In an environment using an actual artificial neural network architecture, there are limitations such as computing resources. Therefore, generating a model that does not exceed these limitations is also one of the issues related to commercialization.

The exemplary embodiment disclosed herein is configured to add an operation term in consideration of the above constraints to the loss function used in the gradient-based search algorithm. The added operation term is for allowing the number of parameters of the candidate operation blocks selected for each stage to converge to the preset target number of parameters. When such a loss function is used, a final artificial neural network architecture in which the number of parameters is converged may be obtained without extra time or resources to be consumed in architecture search.

In an exemplary embodiment, the loss function may be expressed by the following equation.

$$\cdot Parameter Constrained Loss Function \qquad [ Equation 1 ]$$

$$\cdot L = {L}_{task} + λ {L}_{param}$$

$$\cdot {L}_{task} = CE ( A ( {W}_{A} ) , y )$$

$$\begin{matrix}A : SuperNet , & y : GroundTruth , \\ CE : CrossEntropy , & {W}_{A} : SuperNet Weight\end{matrix}$$

$$\cdot {L}_{param} = abs ( \frac{Param}{{Param}_{target}} - 1 )$$

$$\cdot Param = {\sum }_{l}^{L} {\sum }_{i}^{O} param ( {o}_{i , l} ) * softmax ( {o}_{i , l} )$$

$$L : \# layers , o : \# ops , o ∈ O$$

In the above equation, L is a total loss function, Lₜₐₛₖ is a loss function of the existing gradient-based search algorithm, and Lₚₐᵣₐₘ is an operation term for allowing the number of parameters to converge. λ is a weight, which indicates how much Lₚₐᵣₐₘ is to be reflected in the overall loss function. In addition, Param represents the sum of the values obtained by multiplying the number of parameters for each stage by a softmax value of the corresponding operation, and Param_{target} represents the number of target parameters.

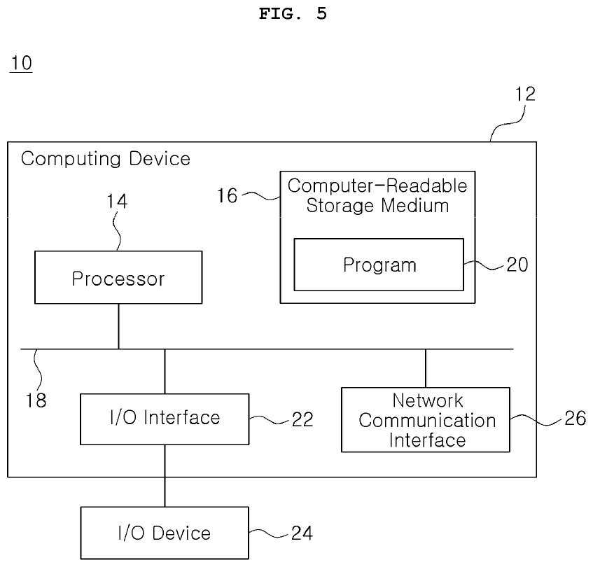

FIG. 5 is a block diagram illustrating a computing environment including a computing apparatus suitable for use in exemplary embodiments. In the illustrated exemplary embodiment, each component may have different functions and capabilities other than those described below, and may include additional components other than those not described below.

The illustrated computing environment 10 includes a computing apparatus 12. The computing apparatus 12 includes at least one processor 14, a computer-readable storage medium 16, and a communication bus 18. The processor 14 may cause the computing apparatus 12 to operate in accordance with the exemplary embodiments described above. For example, the processor 14 may execute one or more programs stored in the computer-readable storage medium 16. The one or more programs may include one or more computer-executable instructions which, when executed by the processor 14, may be configured to cause the computing apparatus 12 to perform operations in accordance with the exemplary embodiment.

The computer-readable storage medium 16 is configured to store computer-executable instructions or program code, program data, and/or other suitable form of information. The program 20 stored in the computer-readable storage medium 16 includes a set of instructions executable by the processor 14. In an exemplary embodiment, the computer-readable storage medium 16 may include a memory (a volatile memory, such as random access memory, a non-volatile memory, or a suitable combination thereof), one or more magnetic disk storage devices, optical disk storage devices, flash memory devices, other forms of storage medium that may be accessed by the computing apparatus 12 and store desired information, or a suitable combination thereof.

The communication bus 18 interconnects various other components of the computing apparatus 12, including the processor 14 and the computer-readable storage medium 16.

The computing apparatus 12 may also include one or more input/output (I/O) interfaces 22 providing an interface for one or more I/O devices 24 and one or more network communication interfaces 26. The I/O interface 22 and the network communication interface 26 are connected to the communication bus 18. The I/O device 24 may be connected to other components of the computing apparatus 12 via the I/O interface 22. For example, the I/O device 24 may include a pointing device (such as a mouse or trackpad), a keyboard, a touch input device (such as a touchpad or touchscreen), a voice or sound input device, various types of sensor devices, and/or input device such as imaging devices, and/or output devices such as display devices, printers, speakers and/or network cards. The exemplary I/O device 24 may be included in the computing apparatus 12, as a component constituting the computing apparatus 12, and may be connected to the computing apparatus 12, as a separate device distinct from the computing apparatus 12.

As set forth above, according to the disclosed exemplary embodiments, by efficiently limiting a search space and updating the same using two algorithms, the gradient-based search algorithm and the evolutionary algorithm, and resource consumption at the network search step may be minimized and the possibility of selecting a better network architecture structure may be increased. Accordingly, according to the disclosed exemplary embodiments, it the overall performance of the artificial neural network architecture search may be improved.

While example exemplary embodiments have been illustrated and described above, it will be apparent to those skilled in the art that modifications and variations could be made without departing from the scope of the present disclosure as defined by the appended claims.

What is claimed is:

1. A method for generating artificial neural network architecture, the method performed in a computing apparatus including one or more processors and a memory storing one or more programs executed by the one or more processors, the method comprising:
selecting one of a plurality of artificial neural network architectures as a backbone architecture comprising one or more stages;
calculating weights of a plurality of candidate operation blocks applicable to each stage for each of the one or more stages;
replacing or removing at least one candidate operation block among the plurality of candidate operation blocks, based on the calculated weight; and
repeatedly performing the calculating of the weight and the replacing or removing of the at least one candidate operation block by a preset number of times to configure final candidate operation blocks set for each stage and select one of the final candidate operation blocks as an operation block of a corresponding stage.

2. The method of claim 1, wherein the calculating of the weights comprises calculating the weights of the plurality of candidate operation blocks using a gradient-based search algorithm.

3. The method of claim 2, wherein a loss function of the gradient-based search algorithm includes an operation term for causing the number of parameters of the candidate operation blocks to converge to a preset target number of parameters.

4. The method of claim 1, wherein the replacing or removing of the at least one candidate operation block includes replacing at least one candidate operation block having a low weight, among the candidate operation blocks, with another candidate operation block.

5. The method of claim 1, wherein the replacing or removing of the at least one candidate operation block includes replacing a candidate operation block having the lowest weight, among the candidate operation blocks, with a candidate operation block having the highest weight.

6. The method of claim 1, wherein the replacing or removing of the at least one candidate operation block includes removing a candidate operation block having the lowest weight, among the candidate operation blocks.

7. A computing apparatus comprising:
one or more processors; and
a memory storing one or more programs configured to be executed by the one or more processors,
wherein the one or more programs include instructions for performing:
selecting one of a plurality of artificial neural network architectures as a backbone architecture comprising one or more stages;
calculating weights of a plurality of candidate operation blocks applicable to each stage for each of the one or more stages;
replacing or removing at least one candidate operation block among the plurality of candidate operation blocks, based on the calculated weight; and
repeatedly performing the calculating of the weight and the replacing or removing of the at least one candidate operation block by a preset number of times to configure a final candidate operation blocks set for each stage and select one of the final candidate operation block as an operation block of a corresponding stage.

8. The computing apparatus of claim 7, wherein the calculating of the weights includes calculating the weights of the plurality of candidate operation blocks using a gradient-based search algorithm.

9. The computing apparatus of claim 8, wherein a loss function of the gradient-based search algorithm includes an operation term for causing the number of parameters of the candidate operation blocks to converge to a preset target number of parameters.

10. The computing apparatus of claim 7, wherein the replacing or removing of the at least one candidate operation block includes replacing at least one candidate operation block having a low weight, among the candidate operation blocks, with another candidate operation block.

11. The computing apparatus of claim 7, wherein the replacing or removing of the at least one candidate operation block includes replacing a candidate operation block having the lowest weight, among the candidate operation blocks, with a candidate operation block having the highest weight.

12. The computing apparatus of claim 7, wherein the replacing or removing of the at least one candidate operation block includes removing a candidate operation block having the lowest weight, among the candidate operation blocks.
